(19) United States
(12) Patent Application Publication
(10) Pub. No.: US 2021/0073812 A1
(43) Pub. Date: Mar. 11, 2021

(54) Multi Format Crypto Token Wallet

(71) Applicant: Scott C. Harris, San Diego, CA (US)

(72) Inventor: Scott C. Harris, San Diego, CA (US)

(21) Appl. No.: 16/948,159

(22) Filed: Sep. 4, 2020

Related U.S. Application Data
(60) Provisional application No. 62/897,280, filed on Sep. 7, 2019.

(51) Int. Cl. G06Q 20/40; G06Q 20/36; G06Q 20/38; H04L 9/06

(52) U.S. Cl. CPC G06Q 20/401; G06Q 20/363; G06Q 20/382; G06Q 2220/00; H04L 2209/38; H04L 2209/56; H04L 9/0637

(57) ABSTRACT

A crypto token wallet which allows storing reduced size ledgers.

This application claims priority from Provisional application No. 62/897,280, filed Sep. 7, 2019, the entire contents of which are herewith incorporated by reference.

### BACKGROUND

Blockchain tokens are used for many different purposes. A very common blockchain token is used for cryptocurrency. Other blockchain tokens such as Ethereum and others can be used for holding many different kinds of information.

Blockchain relies on a distributed ledger which maintains a cryptographically verified and secure version of each transaction being carried out with the blockchain sequence. The ledger is distributed, in the sense that many different parties include identical copies of the ledger.

Users can interact with the blockchain by using their own personal credentials. An electronic file, often called a blockchain “wallet” stores these credentials along with various information about the user's personal stake in the blockchain. For example, a blockchain wallet may store the user's private key that is used by the owner to access the tokens, and in the case of cryptocurrency, to spend the cryptocurrency. The wallet may also store a public key corresponding to the private key, and they also store a digest of the block chain tokens that are associated with the user. In the case of crypto currency, this can include the crypto currency balance. This crypto currency balance is typically just a summary, however, of what is called out in the distributed ledger.

Different kinds of blockchain wallets are known. A blockchain wallet can be stored on the user's own computer, either with or without the distributed ledger. Blockchain wallets can also be stored in apps on a portable phone, or in servers that are accessible by the user with a password. There are also more specific blockchain forms, such as hardware-based blockchain solutions that use special purpose computers or machines to hold and interact with the cryptographic tokens.

### SUMMARY

The inventor recognizes that there are certain advantages to maintaining one's own version of the blockchain under one's own individual control. This gives the user more confidence in the blockchain, since the user stores the entire blockchain on their own computer.

Also, storing blockchain information on a server owned or operated by someone other than the user flies in the face of some of the anonymity and privacy concerns that are touted as advantages of blockchain. However, the distributed ledger for a blockchain, such as bitcoin sequences, can often run to gigabytes or terabytes, thus overloading the capacity of many different hard drives.

An embodiment describes a blockchain wallet and a version of the distributed ledger which provides only parts of the ledger associated with the user's own transactions, along with the additional information that can be used for the user to verify cryptographically that at least part of these transactions are correct.

Since the system provides all necessary aspects for a blockchain, one embodiment describes usability with, which also contains different sections for, different types of blockchain all in the same “wallet” structure. Because the system allows for a reduced version of the distributed ledger, which still maintains information for verifying cryptographic credibility, a “skill” is defined as a software driver that can be used to teach the computer system how to store information for any different kind of blockchain or distributed ledger system, now known or later developed, all within the same basic wallet structure. In one embodiment, all the information can be formed and stored within a single file, even though the information represents different formats of distributed ledger.

### BRIEF DESCRIPTION OF THE DRAWINGS

the drawings show aspects of the invention as described herein and specifically,

FIG. 1 shows a top level view of an exemplary format of a wallet structure according to embodiments with a reduced ledger;

FIG. 2 shows a computer communicating with the server;

FIG. 3 shows a flowchart of operation;

FIG. 4 shows an exemplary layout of the reduced sequence of block chain wallet structure; and

FIG. 5 shows a table illustrating a skill for a specific format.

### DETAILED DESCRIPTION

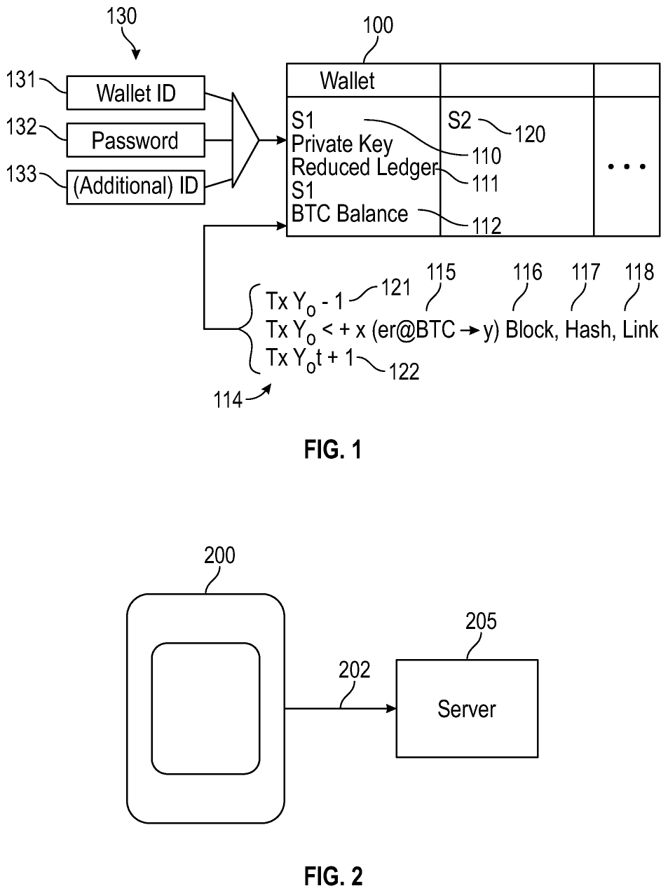

The basic wallet is shown in FIG. 1. The wallet itself shown as 100 is basically a file structure which can be stored on any kind of nonvolatile storage device. The wallet includes a number of different sections including a first section 110 for a first blockchain sequence/format referred to herein as S1. The wallet section 120 is for a second blockchain sequence S2. It should be understood that there can be additional sections for additional blockchains.

Each section may have completely different mathematical necessity; and each section operates according to an “skill” that defines the different features that define the parameters that are stored by the section and the way in which a reduced ledger is formed for the section.

A user, referred to herein as user 0, receives access to the wallet by entering their credentials shown as 130, here a wallet ID 131 which is a special code for the wallet, a password 132, and additional ID 133 that may be set by user 0 as additional security. This latter can be additional identifying information such as a biometric or a 2 factor authentication.

In an embodiment, each section such as 110 stores a reduced ledger 111 which is created from the entire distributed ledger. The reduced ledger forms a reduced data set version of the blockchain ledger. The reduced ledger includes certain information from the distributed ledger, including, the transactions which are associated with the user of the wallet, transactions preceding and following those transactions by a number necessary or desirable to verifiably or cryptographically ascertain the veracity of these transactions, along with identifying information about the transactions so that these transactions can be coordinated with the main distributed ledger during a sync operation.

Each blockchain format has its own set of characteristics, defined by the skill associated with that blockchain. An embodiment is described where the blockchain system is bitcoin, however, there can be many other different formats of blockchain, including “private” blockchain sequences that can be owned by a private party to convey or verify different kind of information.

In bitcoin, the users balance is shown as 112. The ledger stores transactions that are associated with that balance and from which the balance can be verified.

One of the things that is done by crypto currency is using the crypto currency to pay for purchases. Say user 0 has a balance of 0.5 BTC, and wants to pay 0.1 BTC to another party called Y0. The user uses their own private key along with party Y0's public key to transfer the 0.1 BTC from user 0 to party y0.

To carry out this transfer, a transaction is set in the distributed ledger that verifies the transaction. A version of this transaction is shown as 114, referred to as Tx Y0. This transaction in the distributed ledger represents the transfer of 0.1 BTC to Y0.

This also includes additional cryptographic information that cryptographically verifies that the transaction is correct. This additional cryptographic information, for bitcoin, includes a block that is formed by pieces of multiple previous transactions, including a hash value of the previous block, and including a “link” generated with respect to the dependencies of the hash values within the previous block and the following block. This cryptographically prevents tampering with the distributed ledger, since any tampering will defeat the mathematical completeness of the hash and/or link values. In this embodiment, the actual transaction y0 114 represents transferring the 0.1 BTC, also including the block information 116, the hash information 117 and the link information 118.

In order to verify the veracity of this data, the system also stores the previous transaction (Tx y0−1) 121, and the subsequent transaction (Tx y0+1) 122. This can be used to verify cryptographically the hash and the link without consulting the full distributed ledger.

In another embodiment, instead of storing a single antecedent and preceding transaction, the system could store any number of transactions before or after the transaction of interest, e.g. 10 or 100 transactions.

The basic point is that a reduced size ledger is stored, this reduced size ledger having enough extraneous information to allow verifying cryptographically at least some of the data is accurate.

The system also stores the transaction sequence numbers, which are preferably the same transaction sequence numbers that are used in the distributed ledger, so that when the system syncs with the distributed ledger, it can verify that the reduced set of transactions in the reduced set transaction actually synchronize with the data in the full ledger.

In some blockchain formats there can be different kinds of sequence numbers, or none at all.

According to another embodiment, any transactions in the distributed ledger that are older than a specified criteria are also left off of the reduced ledger. For example, transactions which are 5 years old can be removed from the reduced ledger, and either replaced by an indication of “null” or by an indication of “old”.

In an embodiment, this can be stored in a handheld device shown as 200 that communicates via the Internet 202 with a server 205. The server 205 can be the user's home computer, or can be for example a server associated with an app that runs this system. In an embodiment, the system creates the reduced ledger using either the processor in the phone or the processor in the server, or some other cloud-based processor to carry out the following steps. It is recognized that these steps may take significant amounts of time and processing power because of the huge number of transactions included in a blockchain.

However, in some embodiments this only needs to be done once. The values can be synchronized or verified during a phone home by the computer associated with the reduced ledger, however this does not necessarily ever need to be done, unless there is for some reason and inconsistency between the reduced ledger and the full ledger.

The system starts at 300 where the processing element gets either the ledger or a piece of the ledger. For example, if this is being done in a handheld device, processing element may process only a very small part of the ledger at any particular time. For each item in the ledger, the system determines at 310 whether the entry in the ledger is associated in any way with user 0, the owner of the blockchain wallet. If not, the value is kept for N cycles at 315, and then discarded.

If 310 does determine that the value is for user 0, then control passes to 320 which gets N_{Y} of the discards representing the previous N_{Y} discard cycles. The value N_{Y} is a value that is associated with each blockchain format individually and can be specified by the skill for that block chain format. After getting the N_{Y} discards at 320, the system stores the records along with the sequence number, the link and other cryptographic information is defined by the skill.

At 325, the records themselves are stored, for +/−N_{Y} around the item, including all of this data for each of those items. This preferably stores enough data so at least a hash and the link makes sense and can be verified if necessary.

Control continues to pass through this loop, until 330 determines that we are at the end of the sequence. At this point, the system stores the end sequence number at 335 along with the final and N_{z} values predating this sequence number.

The reduced ledger thus stores the last N_{z} entries from the full ledger. When the system later updates to incorporate new ledger entries, the first thing that the system does is compare the last N_{z} stored at 335 with the corresponding ones in the full ledger. This is shown generally as find sequence at 340, which represents the system finding its spot in the sequence of the full ledger to continue the operation of creating the updated reduced ledger until getting to the end at 330.

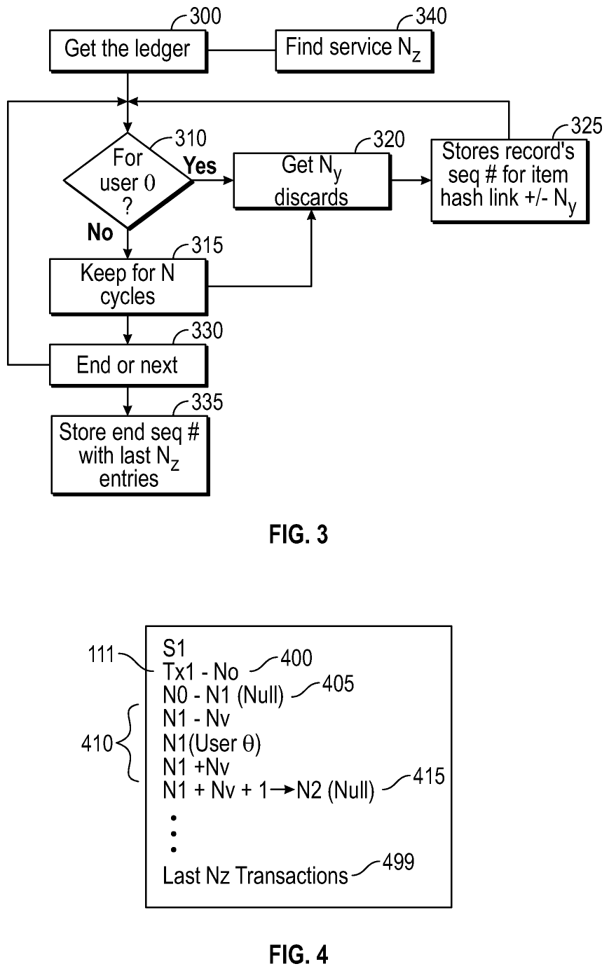

In order to update the reduced sequence, the operation obtains the sequence number which is stored at 335, gets a number of transactions from that sequence number, and compares that with the actual values from the full ledger. These actual values of then compared with the N_{z} values that have been stored, to start the process of comparing at 310. This continues until the end at 330, which again stores values enabling a user to verify the cryptographic integrity. In step 300 of FIG. 3, the reduced sequence starts with the getting the ledger. The end sequence number is stored at 335 so that the next time that the ledger wants to update, it can start at this end sequence number

to assign the bit coin balance to the party why, Once saved, all users who click on the field 400 will receive this information.

An additional or alternate way of reducing the size of the ledger 111 is by setting a maximum number and/or age of the transactions that will be included in the reduced ledger. As one example, users may choose to exclude any transactions which are greater than 100 transactions ago and also more than one year old. Alternatively, the users may simply exclude any transaction greater than a certain age, or greater than a certain transaction number. Users, for example, can thus set the maximum number of transactions that are stored in the reduced ledger, and this function in any case further reduces the size of the reduced ledger.

The reduced ledger 111 for the blockchain defined by S1 is shown in FIG. 4. The ledger includes at the beginning a number of entries, shown as 400, sequence number TX1 through N₀. TX1 is the oldest transaction being monitored by the reduced ledger. This can be, for example, transaction 0 that is the reduced ledger can go back to the beginning of time, or TX0 can be from a certain time period, e.g., 2 years ago, or can be for example the transaction number which corresponds to 100 transactions by user 0, or some hybrid of those different things. This can be, for example, Here N₀ is a value defined by the skill for S1, which defines how many initial transactions should be store as part of the reduced ledger.

After the first sequence of data, there will in general be a null set, extending between N0, and N1, where N1 is the first transaction that involves user 0. The system defines a null set from N0 to N1, which is basically a notation in the file that all of these values do not concern the user 0. However, user 0 does have a transaction at N1, shown by 410 which shows storing both the transaction N1, and values around N1, defined by the value Nᵥ. Nᵥ may be one, or may be more than one, depending on and defined by the skill.

After the first transaction 410 that concerns the user, there will be a second null set (in general) shown by 415. This continues on, until the end set at 499, which stores the last N_{z} transactions.

Each transaction in the reduced ledger stores parameters specified by the skill: typically the sequence number, the information itself, the “hash”, the link, possibly the block, and any other value that can be used to carry out a cryptographic verification.

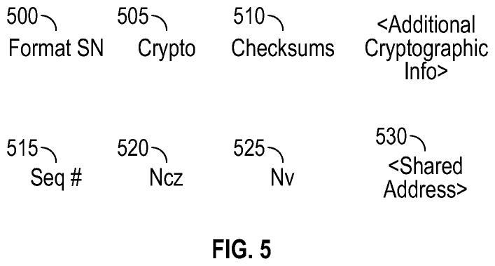

In an embodiment, a skill can be defined for any blockchain or distributed ledger sequence, as shown in FIG. 5. The skill defines for the sequence, how that blockchain should be handled in the wallet, including the format that should be used for the storage, the value before and value after, as well as what kind of data should be stored. The skill forms a map of what the reduced ledger should look like and contain for any blockchain or distributed ledger sequence. FIG. 5 illustrates the specific skill for sequence S_{N}, where the skill sets the format of the blockchain at 500, the crypto of the blockchain at 505, and checksums of the blockchain at 510 where the checksums can be hashes and/or links and/or blocks. 515 represents the format of the sequence number and of the blockchain. In addition, the skill can set the values such as Nz and the other N values at 520 and 525. The skill can also include other information which enables forming a blockchain wallet.

Based on the skill, the system can automatically create a new file which is populated using the shared address 530 which is an address to the distributed ledger.

Although only a few embodiments have been disclosed in detail above, other embodiments are possible and the inventors intend these to be encompassed within this specification. The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A blockchain wallet, comprising
a file storage device, storing a reduced data version of a distributed ledger that is associated with a user, where the distributed ledger is stored by multiple different parties, and where the reduced data version of the distributed ledger provides specified entries of the ledger that are associated with the user's own transactions, the reduced data version of the distributed ledge stores additional information from the ledger, the additional information being sufficient to verify cryptographically that the specified entries of the reduced data version of the ledger are correct, and where the reduced data version of the distributed ledge does not store other entries of the distributed ledger, where the other entries are entries that are not the specified entries.

2. The wallet as in claim 1, wherein the file storage device also stores values indicating a location in the distributed ledger where the reduced data version of the distributed ledger leaves off.

3. The wallet as in claim 1, wherein the file storage device stores a first format of distributed ledger as a first distributed ledger part and also stores a second format of distributed ledger as a second distributed ledger part, all within a single wallet structure.

4. The wallet as in claim 1, further comprising operating using a skill that provides information for a computer system about how to store information for a specific format of distributed ledger within the same wallet structure.

5. The wallet as in claim 1, where the additional information includes at least a hash value relating to previous blocks of information.

6. The wallet as in claim 1, wherein the specified entries representing the user's own transactions include only those which are newer than a specified date.

7. The wallet as in claim 1, further comprising a processor, which processes the distributed ledger, to determine the reduced ledger set, and at any specific time processes new entries in the distributed ledger, and adds specified ones of said new entries to the reduced data set, the specified ones including entries that are associated with the user's own transactions and entries that are necessary to cryptographically verify the entries that are associated with the user's own transactions.

8. The wallet as in claim 1, wherein the specified entries representing the user's own transactions include only a specified number of transactions.

9. A method of forming a reduced size version of a distributed ledger, where the distributed ledger is stored by multiple different parties, comprising:
reading the distributed ledger;
forming a reduced size version of the distributed ledger for a user, including specified entries of the ledger that are associated with the user's own transactions, along with additional information from the ledger, the additional information being sufficient to verify cryptographically that the specified entries of the reduced size version of the ledger are correct, and where the reduced size version of the ledger does not store other entries of the distributed ledger, where the other entries are entries that are not the specified entries; and
storing the reduced size version of the distributed ledger.

10. The method as in claim 9, further comprising synchronizing the reduced size version of the distributed ledger to the distributed ledger.

11. The method as in claim 10, further comprising storing values indicating a location in the distributed ledger where the reduced data version of the distributed ledger leaves off.

12. The method as in claim 9, further comprising storing a first format of distributed ledger as a first distributed ledger and also stores a second format of distributed ledger as a second distributed ledger, all within a single wallet structure.

13. The method as in claim 9, further comprising operating using a skill that teaches how to store information for a specific format of distributed ledger within the same wallet structure.

14. The method as in claim 9, wherein the specified entries representing the user's own transactions include only those which are newer than a specified date.

15. The method as in claim 9, wherein the specified entries representing the user's own transactions include only a specified number of transactions.

16. A method comprising:
reading a distributed ledger that is stored by multiple different parties, and creating and storing a reduced ledger, from the distributed ledger, where the reduced ledger includes transactions for a specified user, and where the reduced ledger includes additional transactions which can be used to cryptographically verify the transactions for the specified user, and where the reduced ledger excludes multiple transactions for users other than the specified user.

17. The method as in claim 16, wherein the reduced ledger also excludes multiple transactions for specified entries representing the user's own transactions which are older than a specified date.

18. The method as in claim 16, wherein the reduced ledger also excludes multiple transactions for specified entries representing the user's own transactions beyond a certain number of transactions.
